(19) United States
(12) Patent Application Publication
(10) Pub. No.: US 2008/0097920 A1
(43) Pub. Date: Apr. 24, 2008

(54) On-line website at which original artistic works are published, reviewed for content, sampled and purchased

(76) Inventors: Navid Aslani, Irvine, CA (US); Ali Jahangiri, Irvine, CA (US)

Correspondence Address: LAW OFFICES OF MORLAND C FISCHER, 2030 MAIN ST, SUITE 1300, IRVINE, CA, 92614, US

(21) Appl. No.: 11/585,190

(22) Filed: Oct. 24, 2006

(51) Int. Cl. G06Q 99/00

(52) U.S. Cl. 705/52

(57) ABSTRACT

A website is disclosed for enabling an artist to publish a plurality of his original works as (e.g., audio, video, and the like) digital files at a channel that is personal to the artist. Provided that the content of the artist's work is acceptable for publication as determined by a previewer, customers of the website can purchase access to the digital files at the artist's channel. In particular, a customer can purchase a subscription for a predetermined time so as to have unlimited access (via browser) to all of the files posted on the artist's channel, the customer can purchase access (via browser) to a single file posted on the artist's channel, or the customer can purchase a download of a digital file from the website to the customer's computer. The website enables the artist to set his own price for allowing customers to access the digital files on his channel or to secure a download, and the artist is paid a royalty depending upon purchases made by the customers. The artist can establish an artist's account at the website so as to monitor, in real time, any royalties due him for payments made by customers to purchase the artist's work.

### BACKGROUND OF THE INVENTION

1. Field of the Invention

This invention relates to an on-line website at which the original works of an artist (e.g., a digital music or video file) can be uploaded and posted, reviewed for acceptable content by a previewer, and sampled and purchased by a customer who logs onto the site and accesses the work. The artist has the ability to select the price at which his work can be accessed and purchased by customers.

2. Background Art

Many talented artists are unable to find a suitable vehicle by which to universally display their original artistic creations so that potential customers can sample and, if satisfied, purchase the work. For example, many artists who write and play music, make movies, paint pictures, take photographs, etc. are often only able to make personal appearances at local shows where their artistic work is offered for sale. Such is the case where the artist is new and must hold a full- or part-time job to support himself. Moreover, it may be cost prohibitive for the artist to travel from show to show around the country and abroad to introduce his work to a geographically diverse audience. Consequently, the opportunity for the artist to attract a large following and generate a corresponding large number of sales is limited.

Some artists who have already become popular are able to have their work offered on-line. However, rarely has there been an attempt by the host of the site to determine whether the artist's work is suitable for all audiences who might visit the site at which the work is published. Thus, some work which is posted to the site may prove to be offensive to certain potential customers. Thus, not only would the artist's reputation suffer, but the artist and the site host may lose their audience and suffer financial harm.

Many artists who agree to have their work offered on-line have no way to control the sale of their work or monitor customer interest and the purchase thereof. That is to say, the artist has no way to establish the purchase price to be paid by customers of the site. In some cases, the artists may, for a limited time, wish to offer his work for free. In other cases, if he or his work has become popular, the artist may want to change (e.g., increase) the purchase price. In most cases, the site does not allow the artist to track, in real time, the number of “hits” by customers who have accessed or purchased his work. More importantly, the artist cannot readily determine the royalties due him from the site host for the sale of the artist's work. In this same regard, there is no mechanism for the artist to receive payments on a regular basis or once the total royalties due exceed a predetermined threshold level.

Accordingly, what is needed is an on-line website where an artist's work can be previewed for content prior to publication, where the artist can control the price of his work, where the artist can reliably track interest and sales activities relating to his work, and where customers to the site can sample and purchase access to the work of their choice.

### SUMMARY OF THE INVENTION

In general terms, disclosed herein is an on-line website and a method by which an artist who has created an original work, a work previewer, a customer of the site, and a site administrator can use the site for the maximum functionality and enjoyment of all. The artist initially creates his personal profile so as to be able to log into the site. The artist then fills out an uploaded page to describe the title and nature of his work (e.g., a digital file containing music, video or other content) that will be uploaded to the site. As an important improvement over conventional sites, the artist determines whether his work can be previewed for free before purchase and how much customers will pay should they ultimately decide to purchase the work. As another important improvement, the artist can establish a channel at which a number of his works will be available to customers of the site. The site also offers the artist the ability to set up his own account so that he can track, in real time, the number of times his work has been accessed and purchased by customers and the total royalties due him by the site host for such purchases. The artist's royalty may also reflect the number of customers who access his work whether or not a purchase is ultimately made.

Prior to the artist's work being uploaded to and published at the site, a previewer designated by the site host is given the opportunity to approve the artist's work for content so as to ensure that it will not be offensive to purchasers according to standards set by the host. The previewer is notified of a new work intended to be published to the site and is given a link by which to access and review the work. If the content is appropriate for the site, the previewer approves the work. The artist receives an e-mail approval notification and the work is posted to the site. If the content is not appropriate for the site, the previewer declines the work. The artist receives an e-mail notification that his work has been declined, whereby his work will be flagged so as not to be available to customers at the site.

A customer initially creates a secure profile page containing personal information such as his name, mailing address, and credit card number for billing purposes. Once he is properly logged in, the customer can browse the site and preview a complete digital file containing the artist's work or sample a portion of the file. If he is satisfied, the customer may purchase the artist's work. In particular, the customer may purchase a subscription from the site to gain unlimited on-line access (via browser) to all of the files on the artist's channel for a predetermined time. The customer may also wish to purchase access (via browser) to a single file on the artist's channel. In the alternative, a file purchased by the customer may be downloaded from the site to the customer's computer. At this point, the purchase price is automatically charged to the customer's credit card. The customer is then provided with a link at the site to the just-purchased file or files so as to have continuous access to the artist's work until his subscription or access rights expire.

The site also has a designated administrator to investigate and correct malfunctions with respect to the operation of the site. In addition, the administrator will look into reports of wrongdoing by an artist. An e-mail is provided from a customer to the administrator through the site to report a malfunction or a possible artist's wrongdoing. If the investigator determines an artist's wrongdoing, the artist's account can be closed and any royalties due for prior sales seized. The artist will then be notified and his work will no longer be accessible to customers at the site.

### BRIEF DESCRIPTION OF THE DRAWINGS

FIG. 1 is illustrative of an on-line website and the various roles, as they relate to the site, played by an artist who has created an original work (i.e., digital file) for publication at the site, a work previewer, a customer of the site, and a site administrator;

FIG. 2 illustrates special features of the website that is shown in FIG. 1;

FIGS. 3A and 3B illustrate details of the steps performed by the artist to use the site to publish his work to be sampled and purchased by site customers;

FIG. 4 illustrates the steps performed by a previewer to access and review the artist's work to ensure that its content is acceptable for publication at the site;

FIG. 5 illustrates details of the steps performed by customers of the site to access, sample and purchase the work of the artist; and

FIG. 6 illustrates details of the steps performed by the site administrator to investigate and resolve functional problems and artist wrongdoings at the site.

### DESCRIPTION OF THE PREFERRED EMBODIMENT

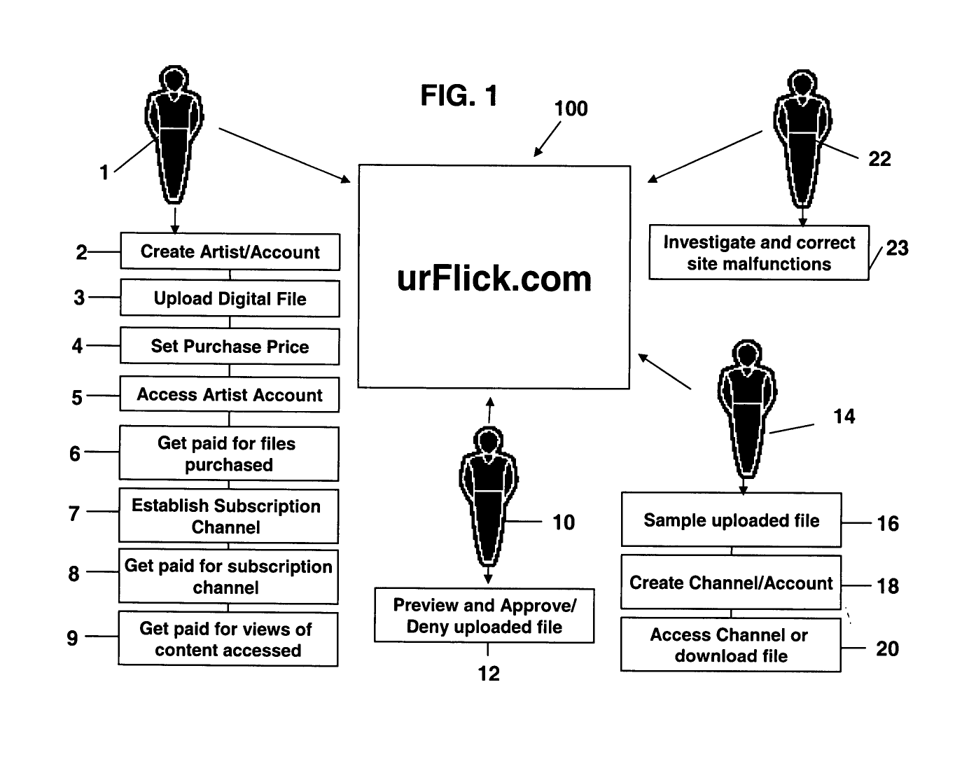

Referring to FIG. 1 of the drawings, there is shown a representation of an on-line website 100 to provide creative artists with a vehicle at which to publish and distribute their original works (e.g., digital files containing video, music, and the like) to a geographically diverse public. In particular, the on-line site 100 is created so that each artist's work can be posted and easily accessed by potential customers of the site to enable the works to be previewed or sampled and, if satisfactory, purchased by the customers. The particular artist is then credited in a personal artist's account he maintains at the site with a royalty that represents a portion of the total purchase price paid by the customer.

The site 100 at which the artist's work is published, previewed and sampled by potential customers, and ultimately purchased has several different users. First, the artist 1 (i.e., the file submitter) initially creates a personal account (step 2) to track interest and payments from customers who access and purchase his original work. Once the artist's personal account has been set up, and provided that the file content is accepted by a previewer 10, the artist uploads (step 3) a digital file that contains his creative work to the site. As an important feature of site 100, the artist has the ability to set the price (step 4) to be paid by customers to the site to gain access to the artist's work for preview and purchase. In this same regard, the artist may initially choose to offer previews of his work to some or all customers for free in order to gain publicity and enable the work to receive maximum exposure.

The artist may, from time to time, access his personal artist's account (step 5) at the site to track the number of “hits” from potential customers who access and preview his work as well as the number of actual purchases made by customers. The total royalty fees owed by the site host and accumulated by the artist for the sale of his work to satisfied customers may also be reviewed by the artist at his account.

As will be explained in greater detail hereinafter, access to the works of the artist can be purchased from the site 100 in different ways. First, a customer 14 of the site can access and preview or sample a work (i.e., a digital file) that has been uploaded by the artist. If the customer 14 is satisfied following preview or sampling, he can tender the purchase price so as to be able to download the file to his own computer. At this point, the artist will receive a royalty payment (step 6) for the downloads purchased by a customer.

In the alternative, and as a unique feature of this site 100, the artist is given the ability to establish a subscription channel (step 7) that is unique to the artist so that all of the works of the artist are available to the customer (via browser) at a single location. As an inducement to the artist to upload a variety of his works to the channel (with the hopes of increasing his royalties as well as the profits earned by the site host), the host will pay the artist (step 8) once his subscription channel has been established having at least a predetermined minimum number of works to be available to potential customers of the site.

The customer 14 will be given different options to access the subscription channel and the artist's works appearing thereon. By way of one example, the customer may elect to pay to the site host (e.g., by means of a credit card account) a subscription fee. In this case, the customer will gain unlimited access (via browser) for a predetermined time to the artist's channel and to all of the artist's files that have been uploaded thereto. In the event that the customer does not wish to pay a subscription fee for unlimited access, he may elect to pay the host a one-time user fee. In this case, the customer will gain access (via browser) to a particular file of the artist at the artist's channel.

Regardless of which option is elected with respect to the artist's channel, the customer will no longer be able to download a file from the artist's channel to his computer. That is, for a prepaid subscription or one-time user fee, the customer will now have ready access (via browser) to the artist's channel and to its content so as to view or listen to a selected file or all of the files that are published thereon. In this same regard, the artist will be paid (step 9) a royalty whenever a customer pays the site host the aforementioned subscription or user fee to gain access to the artist's channel and to one or more of the files available thereat. The artist will also receive a royalty by drawing a certain number of potential customers (i.e., traffic) to his channel even if subscription and user fees are not ultimately paid to the site. The artist can determine in real time the fees paid by customers and the number of customer “hits” on his channel as well as royalties due him from the host by periodically visiting his artist's account (step 2).

It may be that the site host is sensitive to the content of the digital file or files posted by the artist and accessible to customers at the site 100 for downloading or for viewing or listening at the artist's channel. For example, if the site 100 is established primarily to carry religious material or material intended for children, the host may want to ensure that the files that are uploaded to the site will not be offensive to the targeted audience. To accomplish the foregoing, the host designates a previewer 10 who functions as an agent of the host. The previewer 10 accesses and reviews each new work (step 12) once it is uploaded to the site by an artist. Based upon predetermined standards established by the host, the previewer 10 either approves or denies the work for publication. Works which are denied publication are flagged as unsuitable and cannot be accessed or purchased by customers of the site. The artist will be notified should any of his content be flagged by the previewer 10.

A customer 14 is provided with several options to enhance his enjoyment while browsing the site 100. Should he wish, the customer may first preview and/or sample all or a portion of the artist's work (step 16) before deciding whether to pay a subscription or user fee. A preview will give the customer access to a complete file and (at the artist's discretion) be at no cost. A sampling will typically last several seconds and also be at no cost. At the same time, the account that is created by the artist 1 (step 3) will keep track of the number of customers 14 who access, preview and sample a digital file and the fee paid to the site should a particular file or a channel subscription be purchased following preview and sampling.

If the customer 14 intends to frequent site 100 to access files offered by one or more different artists or gain access to different artists' channels, the customer can create a private and secure customer account (step 18). The customer's account will contain personal information, such as name, an e-mail and/or postal address, and credit card data for billing purposes. If the customer does not intend to be a regular visitor to the site, then he need not establish a customer account. In the case of a single (i.e., one time) purchase, the customer will be required to manually enter his identity and credit card information before making a purchase or accessing an artist's channel.

If the customer 14 is satisfied with the artist's work following its preview or sampling, a purchase is consummated (step 20). As previously explained, the customer may decide to make a purchase of the artist's work in different ways. Should he wish to have unlimited access (via his browser) to all of the works of an artist posted on an artist's channel, the customer 14 may wish to purchase a subscription to the channel for a predetermined time at a predetermined price set by the artist. On the other hand, the customer 14 may wish to simply access (via his browser) or download the content of a single file posted by the artist for a different price set by the artist. If a download is purchased, the digital file containing the artist's work is transmitted from the site 100 to the customer's computer or other digital storage device. The customer's credit card listed in his personal account will then be automatically charged to reflect the purchase price. In some cases, it may be necessary to send the purchased file to the customer through the mail.

Once file preview and sampling has been completed and a subscription, access or download fee is paid by the customer 14, a predetermined royalty, as determined by contract with the host, is automatically credited to the account which the artist has previously established (step 2). The royalty paid to the artist represents a portion of the total subscription or file access fees paid by the customer. The balance of the purchase price is retained by the host. The artist may access his account (step 5) at any time to review customer interest in his work or works published on his channel at the site 100 as well as the total royalties due the artist for traffic (i.e., “hits”) to his channel and any purchases made by satisfied customers. The greater the traffic drawn to the artist's channel and the larger the number of individual files and subscriptions purchased by customers, the greater will be the total royalties credited by the host to the artist's account.

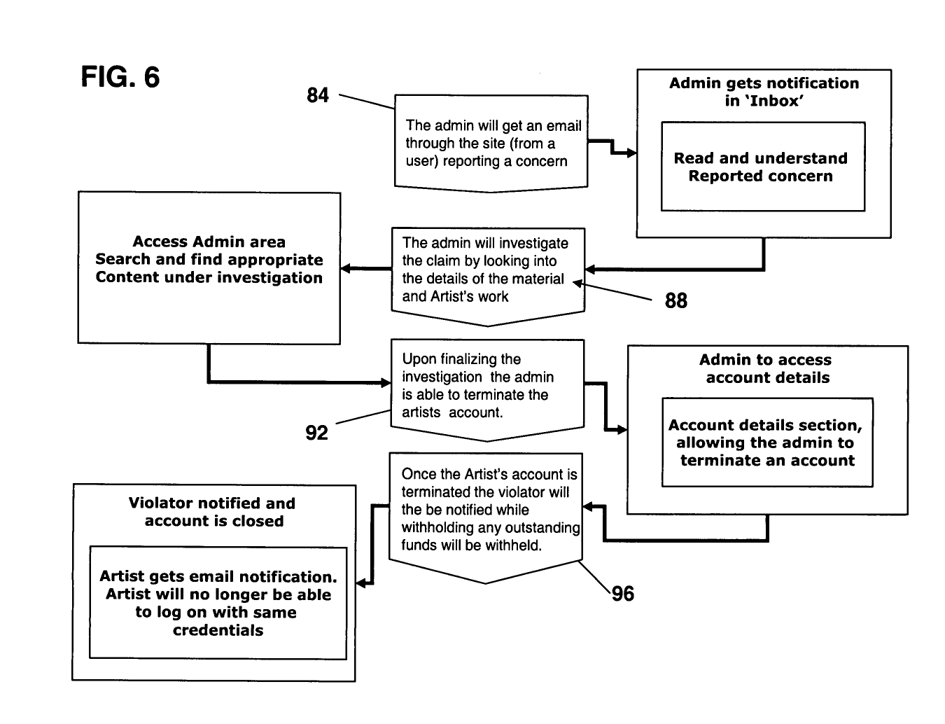

The site 100 is provided with an administrator 22 who is also an agent of the host. As will be explained in greater detail while referring to FIG. 6, the role of the administrator is to investigate and correct malfunctions and any artist wrongdoings (step 23) that are called to his attention by customers of the site so as to ensure a smooth operation thereof.

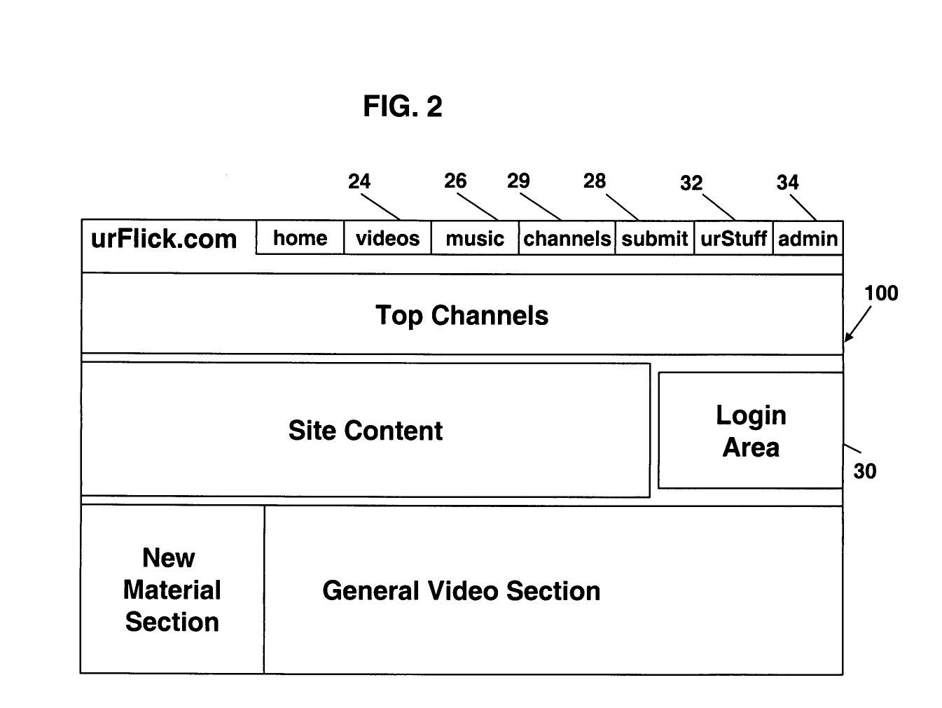

FIG. 2 of the drawings illustrates features and advantages which characterize the website 100 at which the digital files published to the channels of different artists are available to customers for preview, sampling and purchase. By pointing and clicking on different sections of the site, both the artist (designated 1 if FIG. 1) and a customer (designated 14) will be able to navigate the site and open pages for maximum functionality and enjoyment.

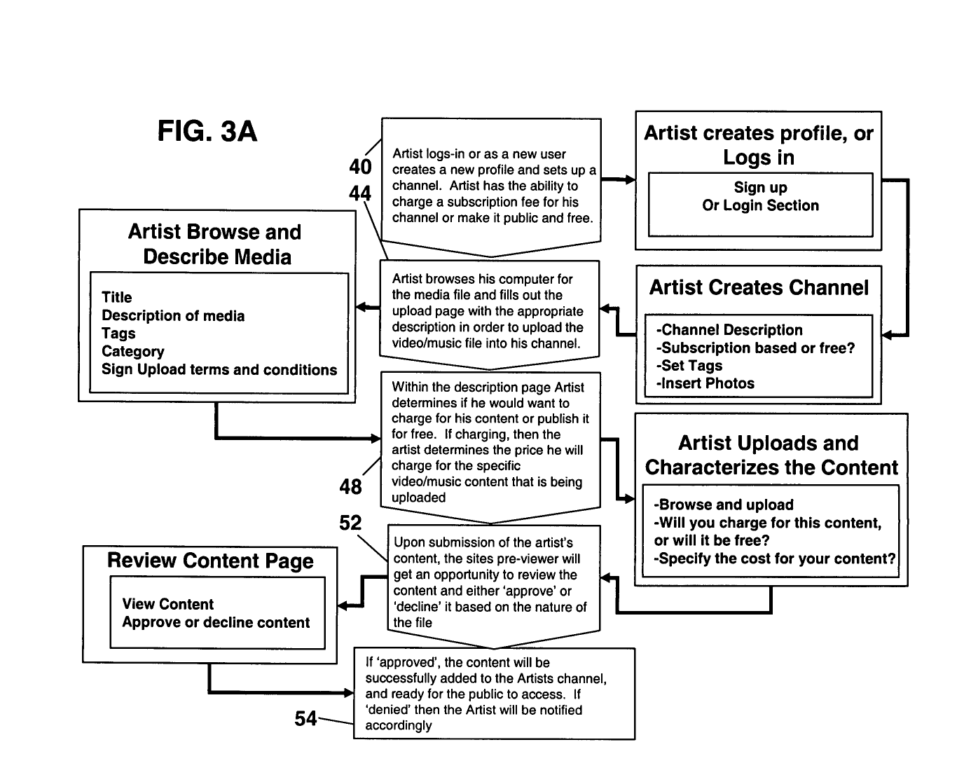

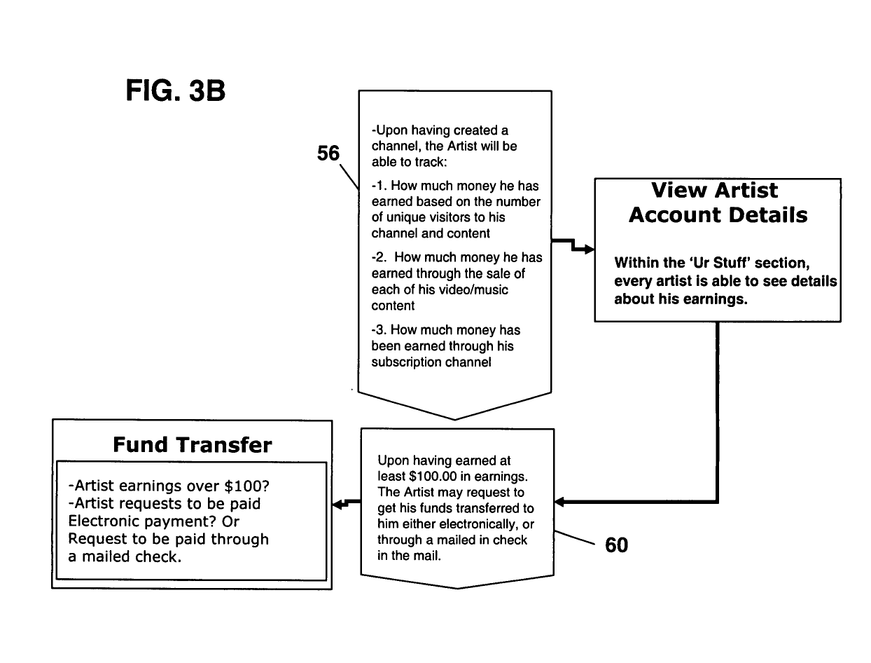

The site 100 is provided with a “VIDEOS” Section 24 that is dedicated to film files from the artists whose video and audio/video works are available to customers. Any viewable file can be accessed from this section. The files are provided with appropriate tags or labels which identify the artist, title of his work, and other related information. Such information may be supplied by the artist in a manner that will be described in greater detail when referring to FIG. 3A.

The site 100 is also provided with a “MUSIC” Section 26 that is dedicated to audio files. Any audio (e.g., music) work can be accessed from this section. Like the previous section 24 for film files, the audio files available at Section 26 will have suitable tags or labels to identify the artist and his work based on information supplied by the artist.

The site 100 is provided with a “SUBMIT” Section 28 which allows artists to upload their original works to be previewed, sampled and purchased by potential customers. Any artist wishing to have his work made available for customer access must first complete a contract with the host of the site. During contract negotiations, the prices set by the artist and the royalties to be paid to the artist at his personal account to reflect customer interest in his work are determined. When a proposed contract has been accepted by the parties, the artist is provided with valid artist log-in credentials which must be used by the artist in order to submit his original content to the site. A “CHANNELS” Section 29 is provided at the site 100 at which customers can access the channels established by artists and the different audio and video works that are available thereat.

The site 100 is provided with a customer log-in “LOG-IN” Section 30. Customers who are already members of the site can log in by using a personal password or similar identification number, whereby to gain access to the site features. New customers who wish to use the site can request their own passwords. At the same time, a customer will have the opportunity to create a secure customer account (step 18 of FIG. 1) so that the customer can preview a file or purchase a subscription to gain access to all of the files at an artist's channel or purchase access to individual digital files on the channel. If a subscription fee is paid or if access to a particular file is purchased, the purchase price will be automatically charged to the customer's credit card at which time the purchased channel or file will be made accessible to the customer (via browser) or transmitted by download to the customer's personal computer or other file storage device (step 20 of FIG. 1).

The site 100 is provided with a Section 32 labeled “UR STUFF.” This section is intended for use by both artists and site customers to sell and buy digital files. On one hand, the customer will be provided with links to all of the files he has purchased (by subscription or download) during any visit to the site. On the other hand, the artist will be able to access his personal account previously established (step 5 of FIG. 1) so as to track, in real time, the customer interest or “hits,” channel subscriptions to and purchases of his work as well as the royalty receipts to be paid by the host to the artist as a result of such “hits,” subscriptions and purchases.

The site 100 is provided with an administrative or “ADMIN” Section 34 to which access is restricted to previewers (designated 10 in FIG. 1) who are responsible for approving or denying the content of the digital files uploaded to the site by the artist and to site administrators (designated 22 in FIG. 1) who investigate and correct site malfunctions. A site administrator is able to view details of the accounts created by the artists so that such accounts can be activated, verified for accuracy, and, as will be explained when referring to FIG. 6, closed, if necessary. A site previewer 10 will receive a list of and the links to the new files that must be reviewed prior to publication at the site. It will be up to the previewer, depending upon standards set by the site host, to either approve or deny the content of the file that is submitted by the artist (step 12 of FIG. 1). If the content is denied, the file will not be published or accessible to customers, and the artist will be notified (via e-mail) of the previewer's negative decision.

The site 100 also offers other features which are intended to attract and hold the attention of potential customers who might be interested in purchasing the genre of audio, video, audio/visual, and other digital files that are made available to them. By way of example only, such additional features include generic information about movies, music, artists, directors, contemporary news headlines, and the like.

FIGS. 3-6 of the drawings illustrate details of the previously described steps performed by each of the artist (designated 1 in FIG. 1), the content previewer (designated 10), the customer (designated 16), and the site administrator (designated 22) with regard to the submission, channel creation, preview, sampling, purchase and administration of the site 100 (of FIGS. 1 and 2) relative to the digital files that are uploaded to and published to the site so as to be accessible to those who are authorized to log in.

FIG. 3A details the actions of the artist 1 (of FIG. 1) prior to submitting and uploading his work (i.e., digital file) to the site. Initially, the artist logs into the site (step 40). In the event that the artist has not previously logged in, he creates a personal profile or log-in page. In this manner, the artist can be identified for the purposes of creating his own account and uploading digital files to the site. Next, the artist browses his computer and locates an upload page (step 44) at which to enter an appropriate description of his work to be submitted. The upload page is completed with information (e.g., artist name, title, media type, etc.) necessary for the site host to properly categorize the work and for customers to be able to locate and access the work. Where the artist will publish a number of his works, a personal artist's channel is created to which customers of the site can gain access (at the “CHANNELS” Section 29 of FIG. 2).

Then, the artist is able to specify if he wishes to offer customers the ability to preview his work for free prior to making a purchase. That is, the artist may decide to allow a predetermined number of customers to preview for free all of the artist's files in their entirety. Other customers will be required to pay a fee to gain access to the files on the artist's channel. As an important advantage over other sites at which digital files are published for purchase, the artist has the ability to set his own price for access to or download of individual files published to his channel. The artist can also set the price for a subscription for unlimited access to all of the files on his channel. The artist may change the purchase prices over time in order to spur sales or to reflect his popularity.

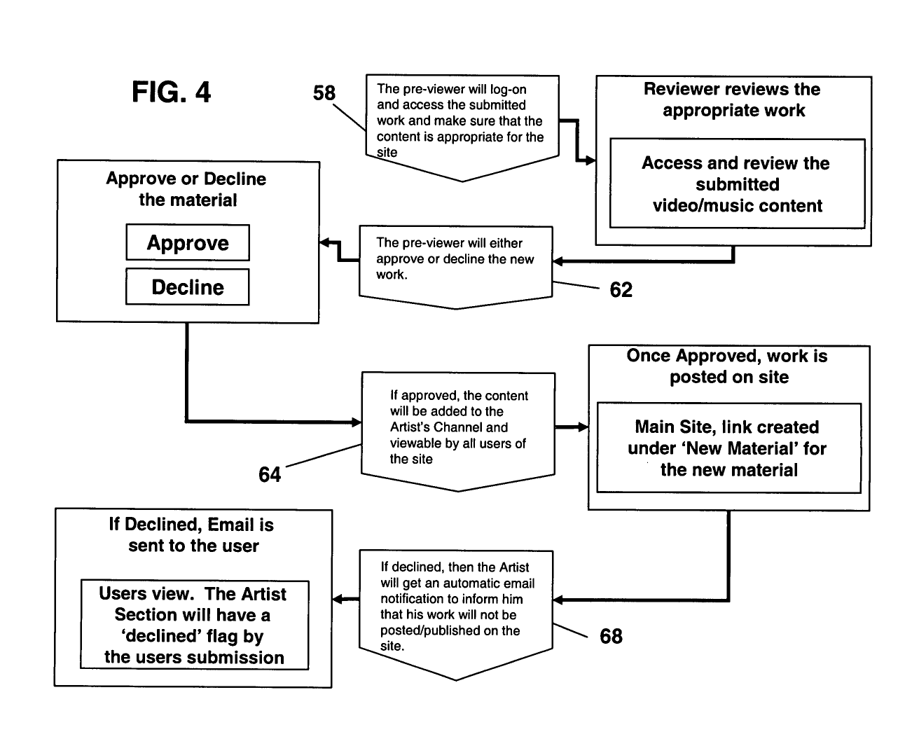

The artist will be able to upload the digital file (or files) of his work to the site at the “SUBMIT” Section (designated 28 in FIG. 2). A panel or a single previewer (designated 10 in FIG. 1) receives an e-mail notification of a new submission (step 52) and a link by which to access and review the content of the artist's work for acceptance or denial. Once the process of uploading his work is complete, the artist receives a notification to confirm that his file has been posted. A link to the site is also provided so that the artist can locate and access his own work. As will be described when referring to FIG. 4, the artist's file will not be made available to the artist or to potential customers of the site if the work is not first accepted by the previewer. If accepted by the previewer, the artist's work will be added to his channel (step 54) to be accessed by customers. If the work is flagged by the previewer, the artist will be notified that the work has been declined.

In FIG. 3B, and provided that the artist's work has first been approved and added to his channel, the artist can track customer activity at the site as it relates to the files he has uploaded (step 56). To this end, and as earlier disclosed, after logging in, the artist can go to the “UR STUFF” Section of the site (designated 32 in FIG. 2) so as to view the number of “hits” by potential customers who visit his channel, the number of purchases (i.e., browser access or file downloads) of individual works, the number of subscriptions to his channel, and the total royalties due the artist by virtue thereof.

As determined in the contract between the artist and the site host, the artist will receive a royalty payment (step 60) depending upon the number of visits (i.e., “hits”) to the artist's channel as well as the number of single files and channel subscriptions that are purchased by customers. Payment to the artist by the host may be tendered periodically (e.g., monthly) or after the artist's accumulated royalties reach a predetermined threshold amount (e.g., $100). Payment to the artist may be by check sent through the mail or via an electronic deposit sent to the artist's designated bank.

The activities of the previewer 10 (of FIG. 1) are detailed while referring to FIG. 4 of the drawings. As earlier described, the previewer logs onto the site and reviews the content of each digital file (step 58) that is submitted (i.e., uploaded) to the site by the artist. The previewer can use any appropriate media player to access the work so that its content can be reviewed according to predetermined standards set by the host so as not to offend the customers to whom the site is directed. The previewer will either approve or decline the work (step 62) to be published at or blocked from the site.

If the content is approved, the artist will be notified (via e-mail) and the digital file containing the artist's work will be posted (step 64) on the artist's channel at the site to be accessed by both the artist and potential customers. For a time, the artist's file may be accessed at a “NEW MATERIAL” Section (of FIG. 2) at the site. If it is otherwise declined because the content of the work is not acceptable, the artist will be notified (step 68) that his work has not been approved for publication. In this case, a “declined” flag will be attached to the digital file to provide a visual indication to the artist that his work will not be posted on the site.

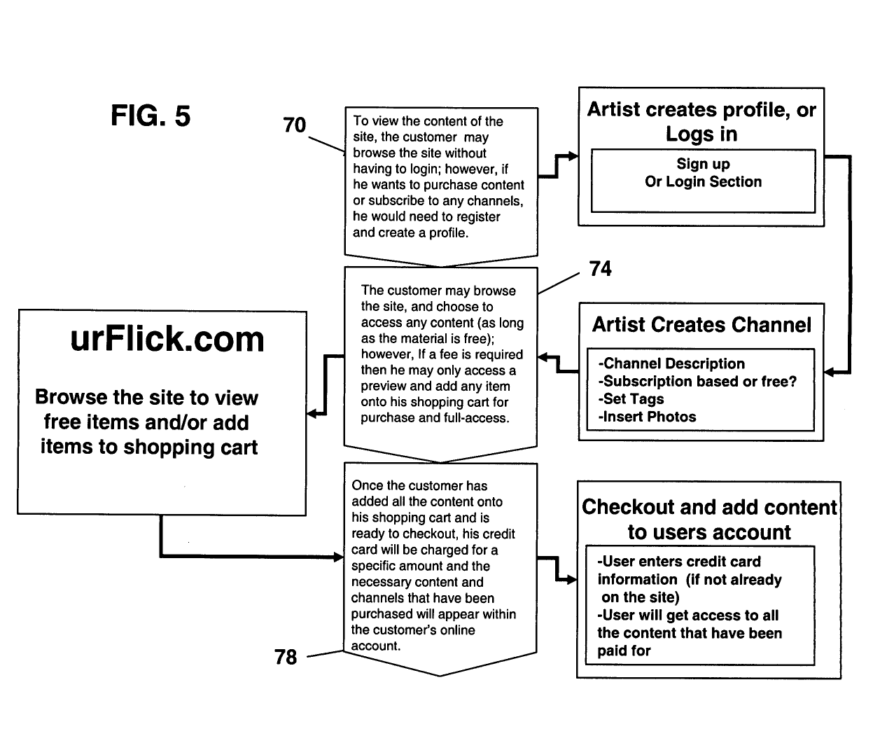

The role of the customer 14 (of FIG. 1) is detailed while referring to FIG. 5 of the drawings. If he wishes to preview or sample an artist's work or make a purchase from the site, an existing customer must log in, while a new customer must first register with the site (step 70). Like the profile that is completed by the artist (step 40 of FIG. 3A), a new customer creates his own personal and secure profile page to obtain a personal password. Prior to logging in, a potential customer may browse the site (step 74) according to his own interests. As earlier described, and provided that there is no charge (as determined by the artist), the customer can freely preview, in its entirety, any file that is posted on the artist's channel. If a free preview is not permitted, then the potential customer will only be able to sample a select portion of the artist's file for free prior to deciding whether to make a purchase.

Once file preview has been completed and access to an artist's channel or to a particular file available thereat has been purchased, the customer's credit card will be charged for the purchase price (step 78). After the file is transmitted (in the event of a download), the customer is given a link to the just-purchased work in the “UR STUFF” Section of the site (designated 32 in FIG. 2). In this manner, the customer will have ready access to the artist's work should additional downloads of the same file be needed in the future.

The role of the site administrator 22 (of FIG. 1) is now detailed while referring to FIG. 6 of the drawings. The administrator is charged with the responsibility of ensuring that the site is functioning properly. If there is an operational problem (e.g., access to a purchased file is not available), the administrator will receive an e-mail (step 84) through the site from the customer. Once being notified, the administrator will investigate the malfunction or other problem (step 88) so as to achieve a timely resolution.

It may be that a problem at the site is caused by the wrongdoing of the artist (e.g., should he attempt to post pornographic or stolen material on his channel). Should this be the case, the administrator may choose to terminate the artist's account (step 92) and seize any royalty payments that have improperly credited by the host. Of course, the original contract between the artist and the site host must provide for the possibility of artist wrongdoing and stipulate the penalties as a consequence thereof. The artist will be notified (via e-mail) that his account has been terminated (step 96), and that any payments that are attributable to his wrongdoing will be withheld.

1. A method for enabling an artist to publish his original works as digital files to a website so that said digital files can be accessed by customers of the website, said method comprising the steps of:
uploading a plurality of digital files to the website which are representative of the original works of the artist to be accessed by the customers of the website;
establishing an artist's channel at the website at which all of the digital files of the artist will be available to the customers;
creating an artist's page at the website at which the artist and each of the artist's digital files at the artist's channel are described;
enabling the artist to set his own price to be paid by the customer to gain access to the digital files posted at the artist's channel;
enabling the customers to purchase access to the digital files depending upon the price set by the artist; and
paying the artist a royalty depending upon purchases made by the customers to gain access to the digital files at the artist's channel.

2. The method recited in claim 1, wherein only those digital files created and uploaded to the website by the artist are available at the artist's channel.

3. The method recited in claim 1, including the additional step of a customer of the website gaining access to all of the digital files posted at the artist's channel by purchasing a subscription for a predetermined period of time.

4. The method recited in claim 1, including the additional step of a customer of the website gaining access to a particular digital file posted at the artist's channel by the customer paying a user fee.

5. The method recited in claim 4, including the additional step of downloading the particular digital file accessed by the customer from the website to the computer of the customer.

6. The method recited in claim 1, including the additional steps of a customer of the website registering and creating a profile with the website at which the customer's identity and credit card information is provided; and charging the customer's credit card for the price set by the artist to be paid by the customer to access the digital files posted at the artist's channel.

7. The method recited in claim 1, including the additional step of permitting a customer of the website to first preview an entire digital file or to sample a portion of a digital file posted at the artist's channel before deciding whether to pay the price set by the artist to gain access to said digital files at said channel.

8. The method recited in claim 1, including the additional step of paying the artist an additional royalty depending upon the number of customers who visit the artist's channel and access one or more of the digital files available thereat.

9. The method recited in claim 1, including the additional step of the artist creating an artist's account at the website and providing at said artist's account an indication of the royalties to be paid to the artist depending upon the payments made by the customers of the website to gain access to the digital files at the artist's channel.

10. The method recited in claim 9, including the additional step of enabling the artist to access his artist's account at the website in order to track in real time the indication of the royalties that are to be paid to the artist.

11. The method recited in claim 1, including the additional steps of designating a previewer to preview for acceptable content each of the plurality of digital files uploaded to the website by the artist to establish the artist's channel prior to making said digital files available to the customers of the website.

12. The method recited in claim 11, including the additional steps of the previewer approving or denying the content of the digital files uploaded by the artist to the website; notifying the artist whether each of said digital files has been accepted or denied prior to making said files available to the customers; and blocking from publication on the artist's channel at the website any digital files whose content has been denied.

13. The method recited in claim 1, including the additional steps of designating an administrator to correct operational malfunctions at the website and wrongdoings of the artist; and providing means through the website by which the customers of the website can communicate with the administrator to report said operational malfunctions and artist's wrongdoings.

14. The method recited in claim 13, including the additional steps of the administrator correcting the operational malfunctions at the website; notifying the artist of a wrongdoing reported by the customers of the website; and stopping payment of any royalty due the artist as a consequence of said wrongdoing.

15. A method for enabling an artist to publish his original work as at least one digital file to a website so that said digital file can be accessed by customers of the website, said method comprising the steps of:
uploading the digital file to the website which is representative of the original work of the artist to be accessed by the customers of the website;
previewing for acceptable content the digital file uploaded to the website by the artist prior to publishing the file at the website and blocking access to said digital file if the content thereof is determined to be unacceptable;
creating an artist's page at the website at which the artist and the artist's digital file having acceptable content are described;
enabling the artist to set his own price to be paid by the customers to gain access to the digital file of the artist;
enabling the customers to purchase access to the digital file depending upon the price set by the artist;
paying the artist a royalty depending upon purchases made by the customers to gain access to the digital file of the artist; and
establishing an artist's account at the website and providing at said artist's account an indication of the royalties to be paid to the artist to reflect payments made by the customers.

16. The method recited in claim 15, including the additional steps of the artist uploading a plurality of digital files representative of different original works to the website; publishing said plurality of digital files at a channel that is personal to the artist; and allowing the customers of the website to purchase access to all of the digital files or to a single digital file at the artist's channel, the royalty paid to the artist including a portion of the price paid by the customers to purchase access to all of the digital files or a single file at the artist's channel.

17. The method recited in claim 16, including the additional step of paying the artist an additional royalty depending upon the number of customers who visit the artist's channel and access one or more of the digital files available thereat.
